(19) United States
(12) Patent Application Publication
(10) Pub. No.: US 2021/0209961 A1
(43) Pub. Date: Jul. 8, 2021

(54) Design method of educational game software sharing function

(71) Applicant: Yuefei SU, Palo Alto, CA (US)

(72) Inventor: Yuefei SU, Palo Alto, CA (US)

(21) Appl. No.: 16/736,254

(22) Filed: Jan. 7, 2020

(51) Int. Cl. G09B 19/00; G09B 5/00

(52) U.S. Cl. CPC G09B 19/00; G09B 5/00

(57) ABSTRACT

The invention provides a design method of educational game software sharing function. The main principle of this method is to visualize the sharing button, vivid the sharing content, personalize the sharing object, and customize the name of the sharing friend. The method includes presetting a copywriting for an educational game software interface that can start a sharing function, adopting a visualized sharing button design, classifying sharing objects for users to choose, presetting sharing copywriting for different sharing objects, and finally forming personalized sharing content. The invention aims at the deficiency of the existing educational game software sharing function design, which can improve the user's learning interest and attract the user group.

### FIELD OF THE INVENTION

A method applied to the design of educational game software. The method can be used in design of sharing function ,and can improve user's learning interest.

### BACKGROUND OF THE INVENTION

During the learning process, students are usually happy to share their learning experience, achievements, rewards, and other information with friends, relatives, and classmates. On the one hand, sharing can meet the psychological needs of students for the sense of honor, on the other hand, it can also disseminate a good learning experience, and attract the attention of the participants to the learning activities. The sharing function in educational game software has a similar effect. With the sharing function, educational game software can not only increase the user's learning interest, but also increase the number of users of educational games.

At present, the common method of sharing functions in educational game software is that the user starts the sharing function, the operation screen pops up a list of applications that can be used for information sharing, the user selects and launches an application, and the user follows the prompt of the selected application to continue and complete sharing. Although this method can complete the sharing of information related to learning activities, the sharing function is not vivid and personalized.

The present invention aims at the lack of existing educational game software sharing function design, and aims at improving the learning interest of users and attracting user groups. Being combined with the educational game software characteristics of design and use, the present invention provides a method of designing an educational game software sharing function.

### BRIEF SUMMARY OF THE INVENTION

In order to make the sharing function of educational game software more vivid and personalized, the main principle of the sharing function design method of the present invention is to visualize the sharing button, vivid the sharing content, personalizing the sharing object, and customizing the names of friends. The specific content of the sharing function design method of the present invention is as follows.

The method to visualize the share button is decorating the share buttons with text and pictures which should be beautiful, coordinate with the content of the educational game software, and reflect the meaning of sharing.

The method to vivid the sharing content is presetting sharing copywriting for the educational game software interface that can start the sharing function operation, making sharing more in line with users' psychological needs.

The method to personalize the sharing object comprises several aspects, including:
setting several options according to the type of sharing object, e.g., father and mother, grandparents, uncles and aunts, classmates, teachers, etc., and allowing editing the name of the sharing object;
after the user clicks the share button, the software displays a software interface containing the above options;
the user selects the desired sharing object option or directly enters text information such as the name of the sharing object. The software presets corresponding information for different categories of sharing objects. The above information will be sent to the sharing target together with the educational game software usage information to be shared;
after the user confirms the operation, the screen displays a list of applications that can be used for information sharing;
the user selects and launches an application, and continues the sharing operation as prompted by the selected application.

The above simplified summary of this invention serves to provide a basic understanding of the present disclosure. This summary is not an extensive overview of all contemplated aspects, and is intended to neither identify key or critical elements of all aspects nor delineate the scope of any or all aspects of the present disclosure.

### BRIEF DESCRIPTION OF THE DRAWINGS

FIG. 1 a schematic flowchart of the embodiment of the sharing function design method.

FIG. 2 a schematic diagram of the preset copywriting corresponding to the software interface that can start the sharing function.

FIG. 3 a schematic diagram of sharing object selection software interface.

FIGS. 4A, B, C a schematic diagram of the preset copywriting corresponding to the sharing object.

### DETAILED DESCRIPTION OF THE INVENTION

In order to make the objectives, solutions, and advantages of the present invention clearer, the following describes details of the method with reference to the accompanying drawings of the embodiment of the present invention. Obviously, the described embodiment are a part of the embodiment of the present invention, not all the embodiment. Based on the embodiment of the present invention, all other embodiment obtained by a person of ordinary skill in the art without creative efforts shall fall within the protection scope of the present invention.

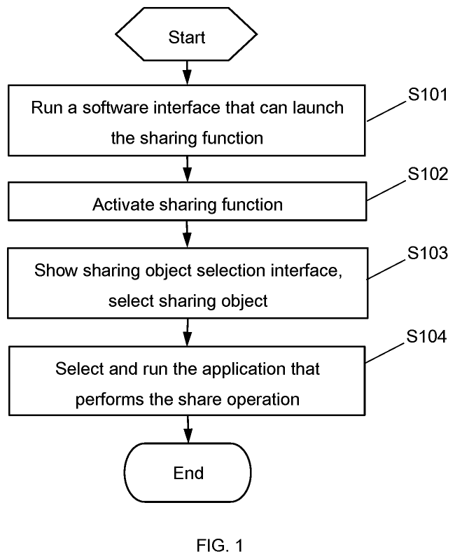

FIG. 1 is a schematic flowchart of an embodiment of a method for designing a sharing function of educational game software provided by the present invention. The operating platforms of the sharing function design method provided by the present invention are mobile phones, tablet computers, notebook computers, and computers. As shown in FIG. 1, the method in this embodiment comprises several aspects or steps.

S101, user runs a software interface that can start the sharing function operation.

The educational game software interface that can start the sharing function operation includes learning badge presentation interface, transcript presentation interface, learning certificate presentation interface, graduation certificate presentation interface, personal growth presentation interface, learning modal presentation interface, prize presentation interface, and learning honors presentation interface, educational game software introduction interface, game currency earning interface, etc.

Each of the above software interfaces can share corresponding content, such as posters.

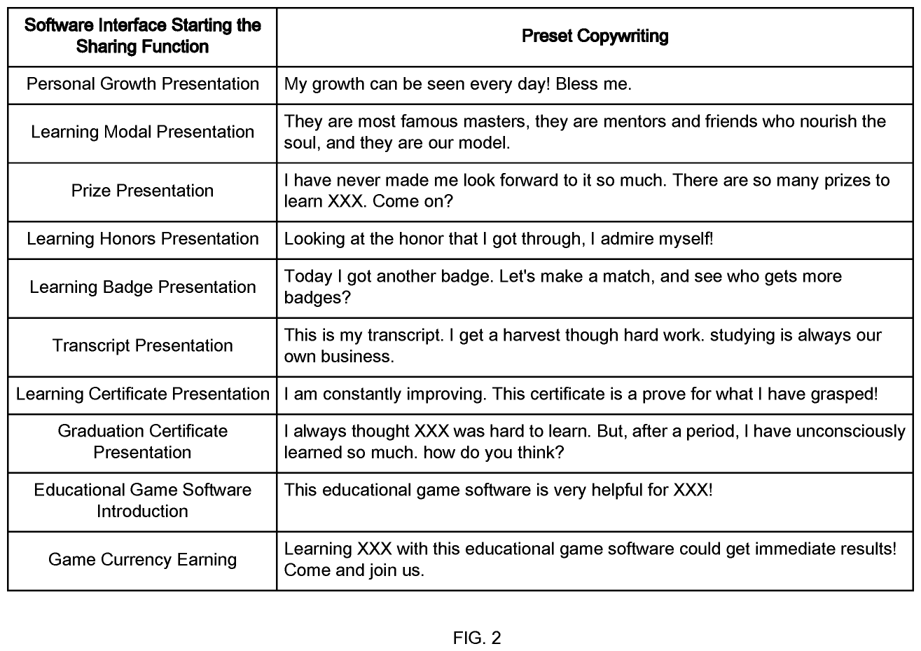

The supporting text information of shared content comes from the corresponding preset copywriting. When the sharing function is activated in the designated software interface, the corresponding shared content, including the preset copywriting, will be determined. As shown in FIG. 2, a schematic diagram of preset copywriting corresponding to a software interface that can start a sharing function.

S102, user activates the sharing function.

On the above software interfaces that can start the sharing function, a button or menu item is set for user to start the sharing function. In order to increase the fun and sense of achievement of sharing, the present invention adopts a visualized sharing button design, that is, using text and pictures to decorate the sharing button. The text and pictures should be beautiful, coordinate with the content of the educational game software and reflect the meaning of sharing.

S103, a sharing object selection interface is displayed for user to choose .

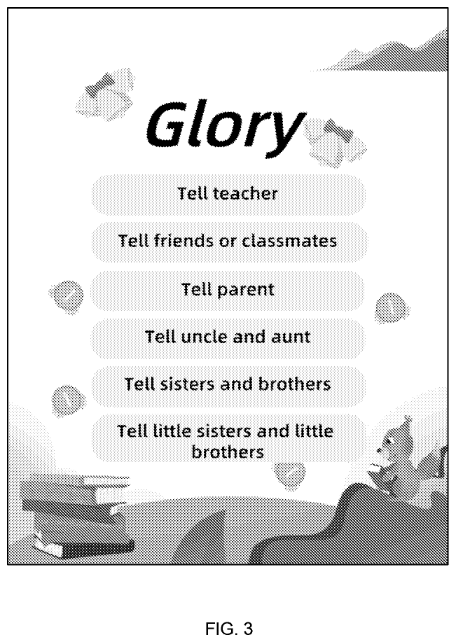

After the user starts the sharing function, the screen displays the interface for selecting the sharing software. As shown in FIG. 3, a schematic diagram of a sharing object selection interface. The sharing object selection interface includes several options, and each option corresponds to a type of sharing object. For example, the sharing objects can be divided into father and mother, grandparents, uncles and aunts, classmates, teachers, and so on.

Or, as prompted by the software, the user could choose to enter a personalized name of the sharing object.

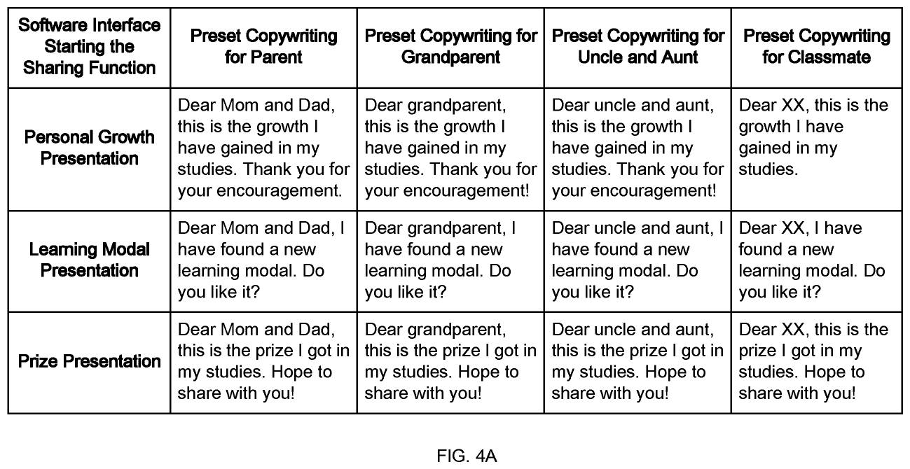

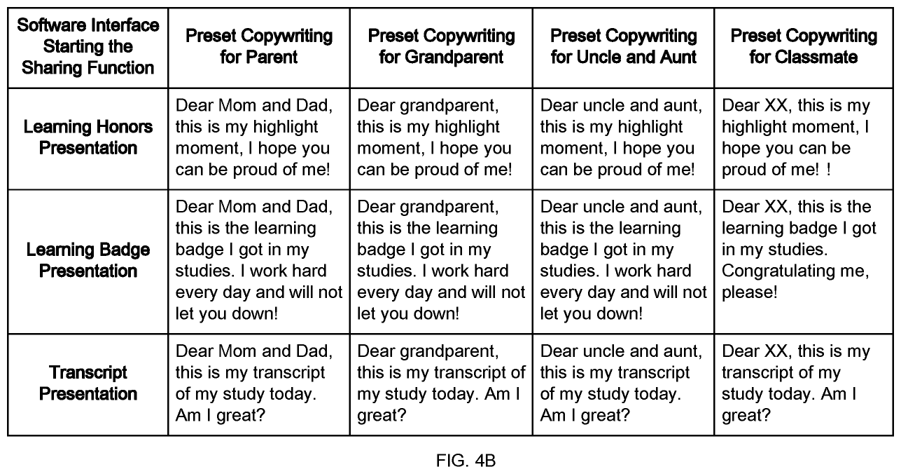

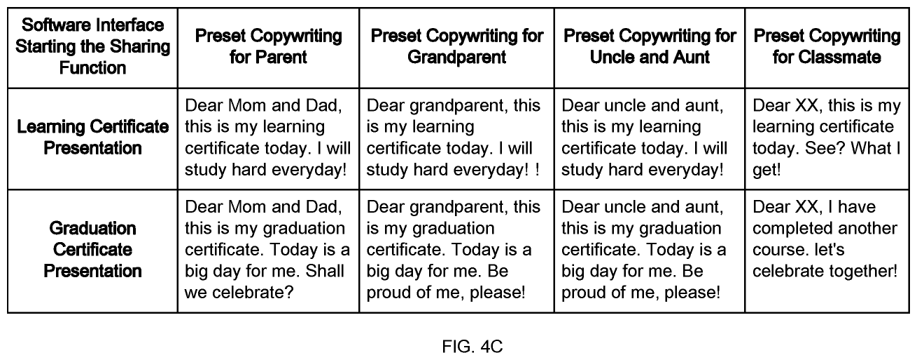

According to the category of the sharing object, or the personalized name entered, the software would generate a preset copywriting, as shown in FIGS. 4A, B, C, a schematic diagram of the preset copywriting corresponding to the sharing object. This copywriting is combined with the shared content and copywriting formed in step S101 to generate the final shared content.

S104 user selects and runs an application program that performs a sharing operation.

User can select and run the application that performs the sharing operation, perform subsequent sharing operations, and send the final shared content generated in S103 to the sharing target.

1. A method for designing an educational game software sharing function, including:
preset sharing copywriting for educational game software interface that can start a sharing function;
visualize sharing button design;
classify the sharing objects for users to choose, preset sharing copywriting for different sharing objects, and finally form personalized sharing content.

2. The methods of claim 1, wherein the method of presetting sharing copywriting for educational game software interface that can start a sharing function, is that sharing copywriting is preset in according to the function of software interfaces which can start a sharing function. These software interfaces include learning badge presentation interface, transcript presentation interface, learning certificate presentation interface, graduation certificate presentation interface, personal growth presentation interface, learning role model presentation interface, prize presentation interface, learning honor presentation interface, educational game software introduction interface, earning game coupon interfaces, etc.

3. The methods of claim 1, wherein the method of visualizing sharing button design is to decorate the share buttons with meaningful text and beautiful pictures which are compatible with the content of the educational game software, and at the same time, embody the meaning of sharing.

4. The methods of claim 1, wherein the method of classifying the sharing objects for users to choose and presetting sharing copywriting for different sharing objects, is to set several sharing objects categories for choosing, and allow users entering the name of the sharing object; generate preset sharing copywriting in according to the category of the sharing object selected by the user or the personalized name entered.
